(19) United States
(12) Patent Application Publication
(10) Pub. No.: US 2005/0030872 A1
(43) Pub. Date: Feb. 10, 2005

(54) Signal restoring device for optical recording media

(75) Inventor: Chih-Ching Yu, Hsinchu (TW)

Correspondence Address: WELSH & KATZ, LTD, 120 S RIVERSIDE PLAZA, 22ND FLOOR, CHICAGO, IL, 60606, US

(73) Assignee: Industrial Technology Research Institute, Hsinchu (TW)

(21) Appl. No.: 10/692,954

(22) Filed: Oct. 24, 2003

(30) Foreign Application Priority Data
Aug. 8, 2003 (TW) 92121815

(51) Int. Cl. G11B 7/00; G11B 5/09

(52) U.S. Cl. 369/59.22; 369/47.18; 369/124.05

(57) ABSTRACT

When restoring signals from an optical recording medium, one usually obtains nonlinearly distorted signals. The equalizer disclosed in the prior art can only process linear signals. A new structure that can process nonlinearly distorted signals is disclosed, which including an A/D converter for sampling restoring signals. The restored signals are processed by an adaptive linear equalizer to extract the errors. The errors are then fed into a nonlinear equalizer for correcting the nonlinear distortion.

### BACKGROUND OF THE INVENTION

1. Field of Invention

The invention relates to a wave equalizer in a signal restoration device for optical storage media and, in particular, to a wave equalizer that uses an adaptive equalizer to correct nonlinear distorted signals when restoring signals from an optical recording medium.

1. Related Art

Generally speaking, optical recording systems have data stored on or read out from a disk in an optical way. The device that is used to read data on the optical recording medium is called the signal restoring device. It generally includes a pickup head for reading data, a pre-amp, a wave equalizer, a data detection circuit, and a decoder.

After the pickup head obtains data signals, the pre-amp amplifies the signals and the wave equalizer equalizes each of the data signals. The data detection circuit detects the binary data from the equalized data signals and outputs the detected signals to the decoder for decoding.

The wave equalizer in the restoring system is mainly used to eliminate the distortion in the data signals. In other words, it converts the recording/restoring channel into a linear model and removes the linear distortion during the data restoring process.

In order to ensure good quality when restoring signals from an optical recording medium, one usually uses a nonlinear equalizer for eliminating nonlinear distortion in addition to a normal linear equalizer as the latter alone cannot achieve a satisfactory effect. There are many reasons for nonlinear distortions. For example, the nonlinear distortion in asymmetric signals is related to the product of the input signal and its one channel bit duration.

Moreover, as the optical recording media have higher storage capacities nowadays, it is almost impossible to build a linear model for the binary data on an optical disk. The primary problem is the system response. Therefore, the establishment of a linear model has to take into account the nonlinear distortion in data signals. It is thus an important subject to solve the problem of nonlinear distortion in the development of a signal restoring system.

In recent years, the development of high-density disks generally uses the signal-reading detection technique in the partial response maximum likelihood (PRML) technology in restoring optical recording medium signals. The purpose of partial response (PR) is to equalize sampled radio frequency (RF) signals into target PR for the detection of maximum likelihood.

The PRML chip has a signal model database. It compares the digital signal obtained from the recording medium with the signal model in the database, finding a closest signal model for output. The hard drive disks (HDD's) on the market have adopted the PRML reading channel. The optical disk drives, or called the signal restoring systems, generally also use the PRML technology. In comparison with the conventional analog trough detection, the PRML makes use of the sampling and frequency responses of digital signals to achieve higher signal stability and storage capacities.

The U.S. Pat. No. 6,052,349 addressed the question of how to eliminate nonlinear distortion and proposed a technical solution. It uses a neural network to build a nonlinear equalizer. However, it requires a huge amount of memory in practice. In one of its embodiments, the device contains over ten multipliers, complicated functional operations, and complex decision mechanisms. Since the linear equalizer and the nonlinear equalize are connected in series, delays happen frequently when extracting feedback signals from the data decoder, making the whole circuit very unstable.

As the nonlinear equalizer using the neural network technology requires a lot of computations, the prior art thus results in many delays during the extraction of feedback signals.

### SUMMARY OF THE INVENTION

In view of the foregoing, it is an objective of the invention to provide a signal restoring device for optical recording media to solve/improve existing technical problem in the prior art. It uses a simpler structure to reduce the amount of necessary multipliers.

When restoring signals from an optical recording medium, nonlinear distortions often occur to the signals when reading or writing the signals. The usual equalizer can only process linear signals. The invention discloses a structure to process nonlinearly distorted signals to achieve the goal of correcting nonlinear distortions.

To achieve the above objectives, the disclosed signal restoring device includes an analog-to-digital (A/D) converter and a wave equalizer. The wave equalizer further contains a first adaptive equalizer and a nonlinear distortion cancellation equalizer. The adaptive linear equalizer is used to perform a linear equalization on the digital signals and to output a target wave and an error signal. The nonlinear distortion cancellation equalizer takes the error signal as its target level. It performs a nonlinear distortion cancellation according to an estimated nonlinear form signal. Moreover, the invention also includes a first adder, which sums up the outputs of the adaptive linear equalizer and the nonlinear distortion cancellation equalizer.

The nonlinear distortion cancellation equalizer further contains a second adaptive linear equalizer and a second adder. The output from the second adaptive linear equalizer is fed back into the second adder so that the second adder can output a second error signal according to the error signal and the feedback signal. The second error is the nonlinear input signal of the second adaptive linear equalizer.

The disclosed signal restoring device modifies the adaptive linear equalizer structure into a nonlinear distortion cancellation equalizer. The number of required multipliers is only related to the complexity of the design. Using the invention, an extremely good signal quality can be achieved with only a few multipliers and without complicated functional operations and decision mechanisms. In comparison with the prior art, there is no such problem as time delays. It has a better feedback control. Its design in the nonlinear distortion cancellation equalizer is also superior to the prior art.

In addition, the disclosed device uses the disclosed nonlinear distortion cancellation equalizer in partial response to achieve effects that are more satisfactory.

### BRIEF DESCRIPTION OF THE DRAWINGS

The invention will become more fully understood from the detailed description given hereinbelow illustration only, and thus are not limitative of the present invention, and wherein:

FIG. 1 is a system block diagram of the disclosed signal restoring device;

FIG. 2 is a schematic view of the disclosed nonlinear distortion cancellation equalizer;

FIG. 3 is a schematic view of an estimated nonlinear signal;

FIG. 4 is a schematic block diagram of the second adaptive linear equalizer;

FIG. 5 is another schematic block diagram of the second adaptive linear equalizer;

FIG. 6 shows the PR output from the linear equalizer only;

FIG. 7 is a histogram for FIG. 6;

FIG. 8 shows the PR output from the linear equalizer and the nonlinear distortion cancellation equalizer; and

FIG. 9 is a histogram for FIG. 8.

### DETAILED DESCRIPTION OF THE INVENTION

In general, one uses nonlinear equalizer to process nonlinear distortion signals. The nonlinear distortion cancellation equalizer is not a truly nonlinear equalizer. The basic concept is as follows. After a signal is processed by an adaptive linear equalizer and equalized by a linear equalizer, the residual error term is extracted to be the nonlinear distortion signal in the signal. The error term is output to the nonlinear distortion cancellation equalizer, whose inputs have to be nonlinear signals. This is because it is a linear equalizer in effect. Therefore, it cannot have any equalization effect if the inputs are linear signals.

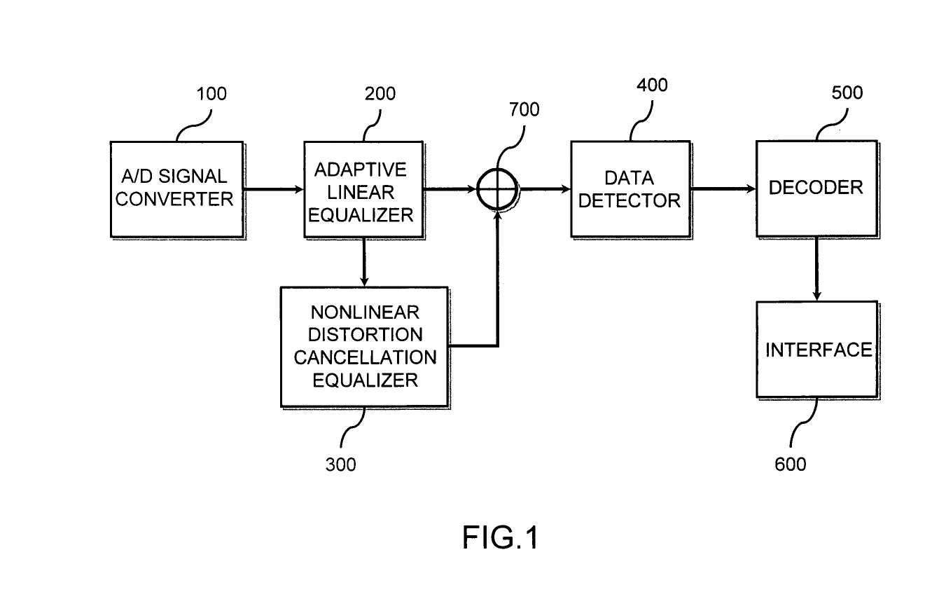

Please refer to FIG. 1. The disclosed signal restoring device contains at least an analog-to-digital (A/D) signal converter 100, an adaptive linear equalizer 200, a nonlinear distortion cancellation equalizer 300, a data detector, 400, and a decoder 500. The input terminal of the adaptive linear equalizer 200 is connected to the output terminal of the A/D converter 100. The error signal output terminal of the adaptive linear equalizer 200 is connected to the output terminal of the nonlinear distortion cancellation equalizer 300. The output terminal of the linear signal is connected to a first adder 700. The first adder 700 simultaneously receives the output from the nonlinear distortion cancellation equalizer 300. After operations, the adder 700 outputs signals to the data detector 400.

The adaptive linear equalizer 200 extracts some signals and feeds them into the nonlinear distortion cancellation equalizer 300. The outputs of the adaptive linear equalizer 200 and the nonlinear distortion cancellation equalizer 300 are added by the first adder 700 to be the input of the data detector 400, recovering the binary data original stored on the medium. Finally, the decoder 500 outputs the resulting data to an external system via an interface 600.

The biggest difference between the disclosed structure and the prior art is that: the invention uses the first adder 700 to process the outputs from the adaptive linear equalizer 200 and the nonlinear distortion cancellation equalizer 300. This greatly reduces signal delays.

The interface 600 is used to communicate with an external system, such as a computer or a television, for outputting restored signals. Of course, the external system also uses the interface 600 along with other circuits to record data signals on optical recording media.

The signal extracted by a pickup head is first amplified by a pre-amp. The resulting radio frequency (RF) signal becomes the input of the A/D converter 100. After processing, the A/D converter outputs sampling signals as the input of the adaptive linear equalizer 200.

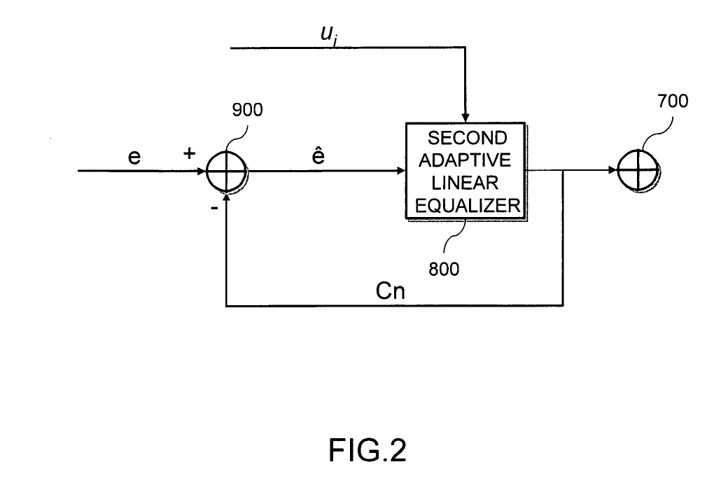

The nonlinear distortion cancellation equalizer 300 further contains a second adaptive linear equalizer 800 and a second adder 900, as illustrated in FIG. 2. The output from the second adaptive linear equalizer 800 is fed back into the second adder 900 so that the second adder 900 can output a second error signal ê according to the error signal e and the feedback signal Cn. The second error is the nonlinear input signal of the second adaptive linear equalizer.

The nonlinear distortion cancellation equalizer 300 is used to eliminate the nonlinear distortions in the signals. The prior art uses a lot of multipliers in the linear and nonlinear equalizers, resulting in signal delays and complicated circuit designs. The disclosed nonlinear distortion cancellation equalizer 300 has a simpler operation model and thus fewer multipliers.

In the partial response channel technology, the data detector 400 is a signal processing circuit using maximum likelihood estimation to detect the partial response in the equalized signals. A preferred embodiment of such a data detector is a Viterbi decoder.

In the following, we give a detailed description for the nonlinear distortion cancellation equalizer 300. The adaptive linear equalizer extracts a target PR and an error value e.

The error value e represents the nonlinear distortion in the signals and is treated as the target level of the nonlinear distortion cancellation equalizer. The input is the estimated nonlinear signal uᵢ. Suppose the output of the nonlinear distortion cancellation equalizer 300 is Cₙ, then

$${c}_{n} = {\sum }_{i} {W}_{i} \cdot {u}_{i} or {c}_{n} = {\sum }_{j} {\sum }_{i} {W}_{i}^{j} \cdot {u}_{i}^{j} ;$$

and the second error signal of the adaptive linear equalizer ê=e−Cₙ.

The parameter of the adaptive linear equalizer is Wᵢⁿ⁺¹=Wᵢⁿ+r·\overline{e}·uᵢ, where r is the step size parameter. The estimated nonlinear signal uᵢ can also be generated from the synthesized signal of the adaptive linear equalizer.

The operation structure for

$${c}_{n} = {\sum }_{i} {W}_{i} \cdot {u}_{i}$$

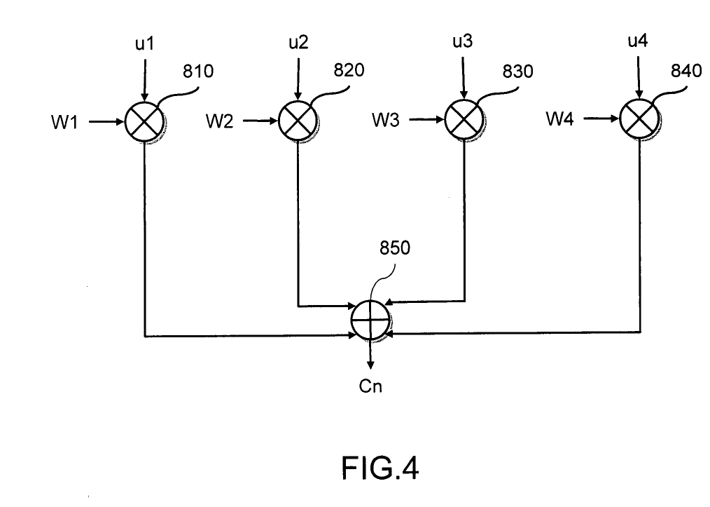

is shown in FIG. 4. Each uᵢ is multiplied by the corresponding weight. For example, the multiplier 810 multiplies u1 with W1, the multiplier 820 multiplies u2 with W2, the multiplier 830 multiplies u3 with W3, and the multiplier 840 multiplies u4 with W4. The multiplication results are added by the adder 850 to output Cn.

The operation structure of

$${c}_{n} = {\sum }_{j} {\sum }_{i} {W}_{i}^{j} \cdot {u}_{i}^{j}$$

is shown in FIG. 5. Each uᵢ here is the delay of the previous uᵢ. For example, u2 is obtained by delaying u1 by one channel bit duration using a delayer 860, u3 is obtained by delaying u2 by one channel bit duration using a delayer 870, and u4 is obtained by delaying u3 by one channel bit duration using a delayer 880. After obtaining the delayed values, the multipliers 810, 820, 830, 840 multiply them by the corresponding weights. Finally, the adder 850 sums them up to output Cn.

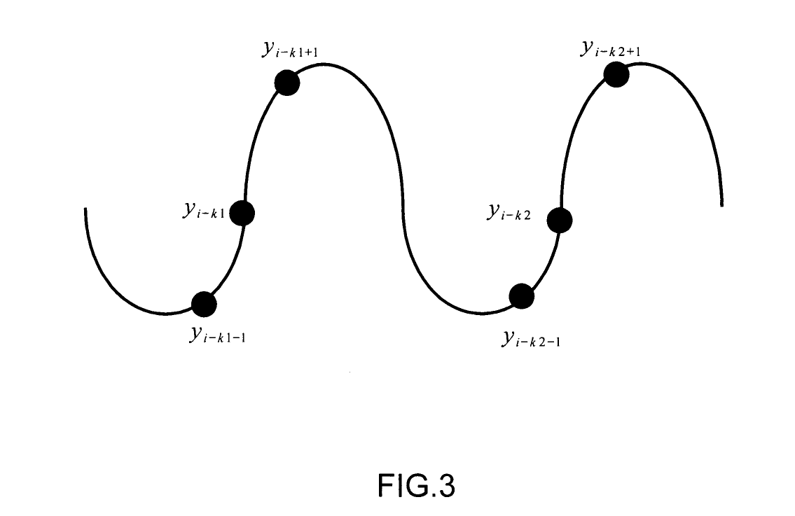

In the following, we give an example of generating u₁. If yᵢ are the RF signal sampling points separated by one channel bit duration. As shown in FIG. 3, since the nonlinear distortion signals usually occur at zero crossing points, uᵢ are selected from:
uᵢ ε{yᵢ₋ₖ₁·yᵢ₋ₖ₂₊₁, yᵢ₋ₖ₁·yᵢ₋ₖ₁₋₁, yᵢ₋ₖ₂·yᵢ₋ₖ₂₊₁, yᵢ₋ₖ₂·y₁₋ₖ₂₋₁}.
That is, each uᵢ is represented by four values: the two coordinates of the zero crossing point and the products of the previous and the next points. Therefore, the generation of each uᵢ requires four multipliers.

Suppose the index j in uᵢ^{j} and Wᵢ^{j} indicates the sampling point separated by one channel bit duration, then

$${c}_{n} = {\sum }_{j} {\sum }_{i} {W}_{i}^{j} \cdot {u}_{i}^{j} .$$

Consequently, if we select uᵢ to be three symmetric TAP adaptive linear equalizers, then each wᵢ^{·} uᵢ requires four multipliers. All four wᵢ ^{·} uᵢ require 16 multipliers. In addition, each uᵢ requires one multiplier. Therefore, the system requires 20 multipliers in total for the four uᵢ in order to achieve extremely good signals.

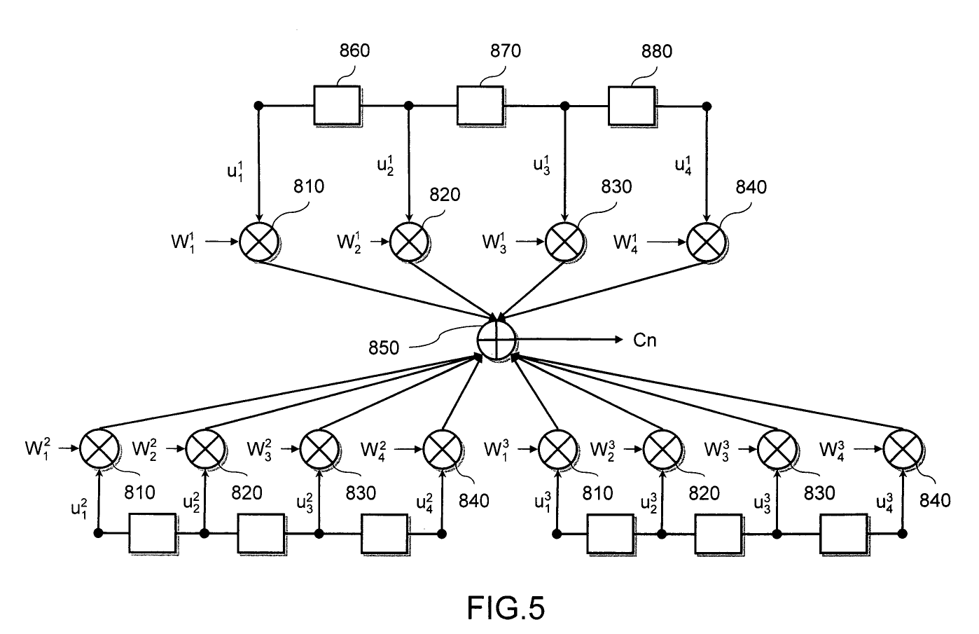

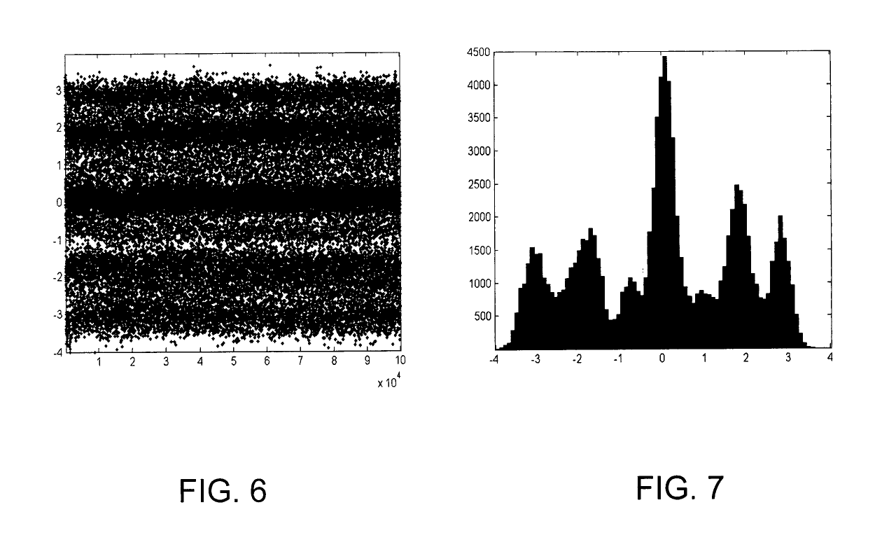

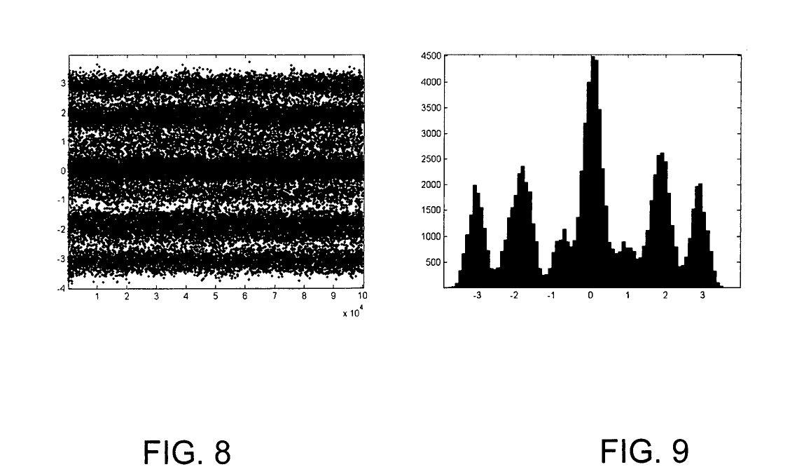

FIG. 6 shows the RF output signal of the adaptive linear equalizer. FIG. 7 is a histogram for FIG. 6. FIG. 8 shows the output signal of the adaptive linear equalizer and the nonlinear distortion cancellation equalizer. FIG. 9 is a histogram for FIG. 8. The nonlinear distortion cancellation equalizer is implemented according to the disclosed embodiment, where 20 multipliers are used. One can easily see that the PR after the insertion of the nonlinear distortion cancellation equalizer accurately falls on the +3, +2, +1, 0, −1, −2, and −3 levels.

Certain variations would be apparent to those skilled in the art, which variations are considered within the spirit and scope of the claimed invention.

1. A signal equalizer for an optical storage medium for detecting a restoring signal from the medium and equalizing a digital signal in the restoring signal into an optimized signal for data detections, the signal equalizer comprising:
an adaptive linear equalizer, which performs a linear equalization on the digital signal and outputs a target wave and an error signal; and
a nonlinear distortion cancellation equalizer, which takes the error signal as the target level of the nonlinear distortion cancellation equalizer and performs a nonlinear distortion cancellation according to an estimated nonlinear signal.

2. The signal equalizer of claim 1 with the nonlinear distortion cancellation equalizer further containing a second adaptive linear equalizer and an adder, wherein the output of the second adaptive linear equalizer is fed back to the adder for the adder to output a second error signal according to the error signal and the feedback signal as a nonlinear input signal for the second adaptive linear equalizer.

3. A signal restoring device for restoring a signal from an optical recording medium for data detections, the signal restoring device comprising:
an analog-to-digital (A/D) converter, which converts the restoring signal sample into a digital signal;
an adaptive linear equalizer, which performs a linear equalization on the digital signal and outputs a target wave and an error signal; and
a nonlinear distortion cancellation equalizer, which takes the error signal as the target level of the nonlinear distortion cancellation equalizer and performs a nonlinear distortion cancellation according to an estimated nonlinear signal.

4. The signal restoring device of claim 3 futher comprising a first adder to sum up the outputs of the adaptive linear equalizer and the nonlinear distortion cancellation equalizer.

5. The signal restoring device of claim 3 with the nonlinear distortion cancellation equalizer further containing a second adaptive linear equalizer and an adder, wherein the output of the second adaptive linear equalizer is fed back to the adder for the adder to output a second error signal according to the error signal and the feedback signal as a nonlinear input signal for the second adaptive linear equalizer.
